(19) United States
(12) Patent Application Publication
(10) Pub. No.: US 2005/0054252 A1
(43) Pub. Date: Mar. 10, 2005

(54) Recyclable, multi-layer packaging material capable of water absorption and desorption

(76) Inventors: Radu Baciu, New Westminister (CA); Martin Vido, Mission (CA)

Correspondence Address: MADSON & METCALF;GATEWAY TOWER WEST, SUITE 900, 15 WEST SOUTH TEMPLE, SALT LAKE CITY, UT, 84101, US

(21) Appl. No.: 10/483,028

(22) PCT Filed: Jun. 19, 2002
(86) PCT No.: PCT/CA02/00920

(30) Foreign Application Priority Data
Jul. 6, 2001 (CA) 2352518

(51) Int. Cl. B32B 5/16; B32B 27/12; D03D 15/00; B32B 5/26

(52) U.S. Cl. 442/192; 442/182; 442/286; 442/268; 442/294; 442/301; 442/290; 442/277; 442/284; 442/285

(57) ABSTRACT

A composite sheet material suitable for use as a wrapping material having a layer of non-woven material formed from thermoplastic fibers or spunbonded fabric and a single or a composite water impermeable layer, the layers being laminated together. The composite impermeable layer may include a polymeric woven scrim for increasing the tensile strength and tear strength of the sheet.

### FIELD OF THE INVENTION

The invention relates to a composite sheet material formed by at least one layer of non-woven fabric laminated on one side to a water impermeable layer. The sheet material is suitable for use as a wrapping material and as an industrial and agricultural fabric.

### BACKGROUND OF THE INVENTION

Various composite sheet materials have been made for use in the packaging industry. For some applications, such as lumber wraps, water impermeable wraps may create sweating inside the package due to humidity. For this reason lumber wraps sometimes include a water-absorbing layer such as kraft paper on the inside. Kraft paper of weights of 65 to 200 grams per square meter are usual in the industry. They absorb a greater weight of water than their original weight and release moisture gradually under drier conditions without sweating. A paper layer can also be used to incorporate additives such as anti-fungal, anti-staining and anti-mildew compositions and, in case of metal wraps, additives such as liquid corrosion inhibitors.

It is well known that plastic and paper can easily be recycled separately but not together. Disposing of wraps comprising both plastic and paper has become a major problem to the users. It would be desirable for such packaging material to be made from materials that can be recycled together.

Other prior art products include laminates of a non-woven textile material and a water vapour permeable film, as in WO 94/19178, published Sep. 1, 1994, for use as wrapping material; and a laminate of polyvinyl acetate having ultraviolet shielding properties laminated to a non-woven fabric, egg. Japanese Patent Abstract JP 921565 97.

### SUMMARY OF THE INVENTION

It is an object of this invention to provide a composite is sheet material that absorbs moisture and is capable of Incorporating various additives while allowing those additives to exit gradually from the surface of the inside layer.

It Is a further object of this invention to provide a composite sheet material that is resistive to water from the outside surface. This outer layer protects the packed goods from environmental hazards and can Include UV-resistive compounds and other additives.

It is a further object of this invention to provide a composite sheet material that is recyclable.

According to one embodiment, the Invention provides a flexible sheet material, suitable for use as a protective wrapping material and other uses, comprising a non-woven fabric layer and a water-impermeable polymer layer. The non-woven fabric is preferably made of the same general kind of polymer as the water-impermeable layer, eg. both polyolefins, The non-woven fabric layer used in the invention is a hydrophilic fabric made fromn polymeric fibers or is a spunbonded fabric. This layer is capable of absorbing and releasing moisture.

The non-woven fabric layer is preferably capable of incorporating various additives such as liquid vapour corrosion inhibitors, anti-fungal compositions, anti-staining compositions, liquid flame-retardants, etc.

According to a further embodiment, the sheet material may include a woven scrim for Increasing the tensile strength of the material and the tear strength. The woven scrim may optionally be coated on the outer side. The outer layer of the sheet material may carry additives such as UV-resistive compounds for increased protection of the wrapped goods,

### BRIEF DESCRIPTION OF THE DRAWINGS

FIG. 1 is a cross-sectional view through one embodiment of the sheet material according to the Invention.

FIG. 2 is a cross-sectional view through a second embodiment of the sheet material.

FIG. 3 is a cross-sectional view through a third embodiment of the sheet material.

### DETAILED DESCRIPTION OF THE PREFERRED EMBODIMENTS

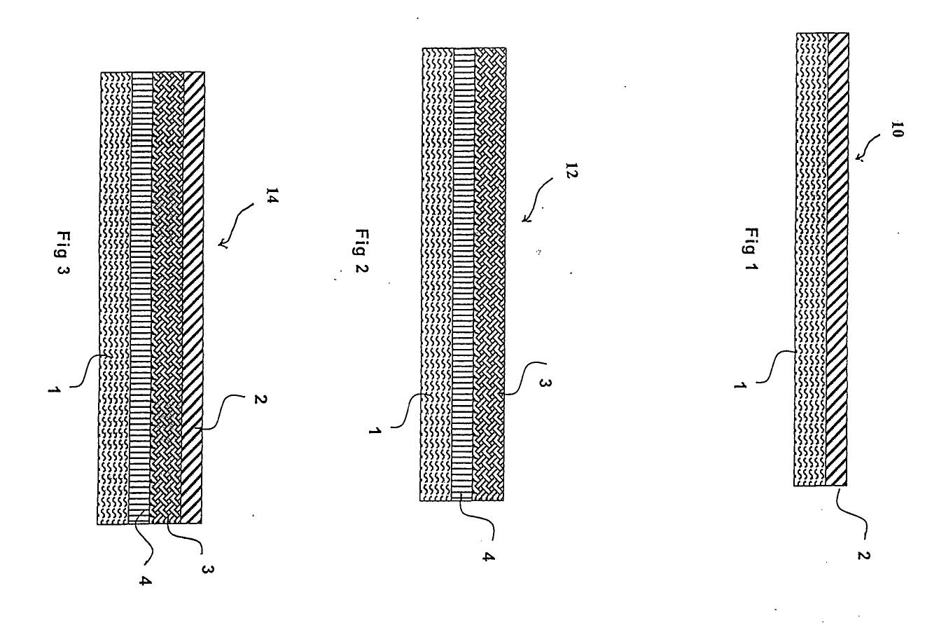

The Invention provides a sheet material which is used as packaging wrap. Referring to FIG. 1, which shows the simplest embodiment of the Invention, the sheet material 10 comprises a non-woven fabric layer 1. Layer 1 is formed from thermoplastic fibers or spunbonded fabric, preferably with widths up to 6 meters (20 feet), weight ranges from 15 to 200 grams per square meter, and densities from 100 to 600 kilograms per cubic meter. Non-woven fabric layer 1 is capable of absorbing moisture inside the package, when the sheet material is used for packaging, and then desorbing it when the package is unwrapped and permitted to air dry.

The non-woven fabric 1 may be made from any suitable polymeric resin, preferably a polyolefin, more preferably polypropylene or polyethylene.

The non-woven fabric of layer 1 is hydrophilic. The go property of hydrophilicity Is imsparted to the non-woven fabric by methods well known in the art, such as by treatment with surfactants such as polyvinyl alcohol, hydroxy propyl methyl cellulose and others. Hydrophilic non-woven fabrics suitable for use in the invention are commercially-available products.

The non-woven layer 1 may be impregnated with one or more of various additives, such as liquid vapour corrosion Inhibitor, liquid flame retardant, anti-staining compositions and anti-fungal compositions, depending on the application to which the sheet material is to be put.

The non-woven fabric 1 is laminated on one side to a thin layer of thermoplastic film 2, preferably 0.2 to 4.0 mils In thickness and preferably 5 to 100 grams per square meter in weight. Layer 1 is the inside layer of the sheet material when it is used for wrapping. Film 2 can be made from any suitable polymer resin, preferably a polyolefin, and more preferably low density polyethylene.

Layer 2 has a low vapour transmission rate. It protects the wrapped goods from environmental hazards such as rain and dirt and, if required, may carry one or more of additives such as UV-resistive compounds, flame-retardant compositions, corrosion-inhibiting compositions and color pigments.

In the second embodiment, shown In FIG. 2, the sheet material includes a woven scrim 3, laminated to the non-woven fabric layer 1 by means of a laminating film 4. The woven scrim 3 is preferably made from polyolefin tapes woven in the machine and cross directions with pie counts of about 8 by 3 tapes per square inch. The scrim 3 provides tensile strength in both directions as well as tear strength. The laminating film 4 is similar to coating layer 2. It is a thermoplastic film, preferably a polyolefin, with a thickness preferably ranging from 0.2 to 4.0 mils and a weight preferably In the range of 5 to 100 grams per square meter. The laminating film 4 and the woven scrim 3 may contain one or more of additives such as UV resistive compositions, flame-retardant compositions, corrosion-inhibiting compositions and color pigments.

In the third embodiment, shown in FIG. 3, the sheet material is the same as the embodiment of FIG. 2, except that a water impermeable thermoplastic film layer 2 (of the same composition as layer 2 In FIG. 1) is laminated to the outer surface of woven scrim 3.

In all three embodiments, non-woven fabric layer 1 Is the inside layer when the sheet material Is used for wrapping.

The laminated sheet materials of the invention may be made by any conventional method used for making laminated plastic films. For example, the non-woven layer can be fed off a feeder roll and passed through a pinch point between two rollers and onto a windup roller. The thermoplastic film 2 can be extruded onto the non-woven fabric immediately before the pinch point, forming a laminated product, which is wound up onto the windup roll.

Although intended primarily for use as a packaging material, for example, for wrapping lumber and metal goods, the sheet material of the invention also has utility as an industrial and agricultural fabric. Applications for such fabrics include use as geomembranes, covers for temporary building structures, landfill covers, pond liners and hay tarps.

### EXAMPLE

Samples of hydrophilic non-woven fabric sheets made of polypropylene having various weights and densities were selected. They were tested for water absorption by immersing them in water for various periods of time from one minute to 60 minutes. A sample of paper (kraft paper having a weight of 65 grams per square meter) was also tested. The details of the tests and their results are stated in Table 1.

TABLE 1
Water absorption of polypropylene non-
woven fabrics compared to 65 grams per square meter kraft paper
over the period of one hour

| | | | Water absorption during | | | |
|---|---|---|---|---|---|---|
| Sample | Weight | Density | various periods of time | | | |
| No. | (g/m²) | (kg/m³) | 1 min | 5 min. | 30 min. | 60 min. |
| 1 | 66 | 110 | 124% | 154% | 160% | 187% |
| 2 | 51 | 86 | 285% | 290% | 296% | 296% |
| 3 | 45 | 88 | 113% | 124% | 122% | 127% |
| 4 | 58 | 103 | 98% | 110% | 112% | 117% |
| 5 | 82 | 117 | 136% | 137% | 135% | 136% |
| 6 | 37 | 91 | 176% | 180% | 178% | 184% |
| 7 | 85 | 98 | 283% | 295% | 298% | 297% |
| 8 | 53 | 92 | 205% | 209% | 216% | 214% |
| Paper | 85 | 104 | 89% | 94% | 112% | 112% |

A second series of the same kind of tests was conducted on the same kind of samples as in Table 1 after the non-woven sheets were laminated to an impermeable film (as in FIG. 1) or additionally to include a woven scrim (as in FIG. 2 or 3). The details of the tests and their results are stated In Table 2.

TABLE 2
Water absorption of coated polypropylene
non-woven fabrics compared to coated 65 grams per square meter
kraft paper over the period of one hour

| | | |
|---|---|---|
| | | Water absorption during |
| Sample | Weight | various periods of time |

| No. | (g/m²) | 1 min | 5 min. | 30 min. | 60 min. |
|---|---|---|---|---|---|
| 1 | 66 | 109% | 111% | 112% | 114% |
| 2 | 51 | 81% | 88% | 87% | 88% |
| 3 | 45 | 57% | 59% | 76% | 77% |
| 4 | 58 | 58% | 58% | 59% | 58% |
| 5 | 82 | 76% | 79% | 79% | 78% |
| 6 | 37 | 52% | 60% | 74% | 73% |
| 7 | 65 | 123% | 139% | 143% | 146% |
| 8 | 53 | 91% | 96% | 103% | 101% |
| Paper | 65 | 48% | 59% | 81% | 62% |

The samples of Table 2 were air dried by means of blowing air, without heat, for a period of 180 minutes, with the percent weight loss being measured at intervals. The results are set out in Table 3.

TABLE 3
Water desorption of coated polypropylene
non-woven fabrics after one hour of water absorption compared to
coated 65 grams per square meter kraft paper

| | | % gained | % weight loss | | | |
|---|---|---|---|---|---|---|
| Sample | Weight | during | during drying | | | |
| No. | (g/m²) | 1 hr absorption | 16 min | 60 min | 105 min | 180 min |
| 1 | 66 | 114% | 91% | 41% | 0 | 0 |
| 2 | 51 | 88% | 59% | 0 | 0 | 0 |
| 3 | 45 | 77% | 45% | 0 | 0 | 0 |
| 4 | 58 | 58% | 36% | 0 | 0 | 0 |
| 5 | 82 | 78% | 59% | 8% | 0 | 0 |
| 6 | 37 | 73% | 40% | 0 | 0 | 0 |
| 7 | 65 | 146% | 120% | 48% | 0 | 0 |
| 8 | 53 | 101% | 76% | 8% | 0 | 0 |
| Paper | 65 | 62% | 42% | 10% | 3% | 0 |

As will be apparent to those skilled in the art in the light of the foregoing disclosure, many alterations and modifications are possible in the practice of this invention without departing from the scope thereof. Accordingly, the scope of the invention is to be construed In accordance with the substance defined by the following claims.

1. A protective wrapping material which comprises a flexible composite sheet material comprising:
(a) a layer of hydrophilic non-woven fabric made from thermoplastic polymer fibers;
(b) a water-impermeable thermoplastic polymer film laminated to layer (a); and
(c) a layer of woven thermoplastic polymer tapes laminated to the outside of said polymer film.

2. A wrapping material according to claim 1 further comprising a second water-impermeable thermoplastic film, said film being laminated to the outside of said woven layer.

3. A composite material according to claim 1 wherein said non-woven fabric is a spunbonded fabric.

4. A wrapping material according to claim 1, wherein said non-woven fabric contains one or more of the following:
(a) anti-fungal composition;
(b) anti-staining composition;
(c) flame-retardant composition; and
(d) corrosion-inhibiting composition.

5. A wrapping material according to claim 1 wherein said polymer film contains one or more of the following:
(a) UV-resistant composition;
(b) flame-retardant composition;
(c) color pigment; and
(d) corrosion-inhibiting composition.

6. A wrapping material according to claim 1 wherein said layer of woven thermoplastic polymer tapes contains one or more of the following:
(a) UV-resistant composition;
(b) flame-retardant composition; and
(c) color pigment.

7. A wrapping material according to claim 1, wherein said non-woven fabric and said polymer film comprise polyolefins.

8. A wrapping material according to claim 1 wherein said woven polymer tapes comprise polyolefins.

9. A wrapping material according to claim 2 wherein said second thermoplastic film comprise polyolefins.

10. A wrapping material according to claim 1 wherein said non-woven fabric is polypropylene.

11. A wrapping material according to claim 2 wherein said second thermoplastic film comprises low density polyethylene.

12. A wrapping material according to claim 1 wherein said non-woven sheet is made hydrophilic by the application thereto of a surfactant.

13. A wrapping material according to claim 1 wherein said non-woven fabric has a weight in the range of 15-200 grams per square meter.

14. A wrapping material according to claim 1 wherein said polymer film has a thickness in the range of 0.2-4.0 mils.

15. A wrapping material according to claim 1 wherein said polymer film has a weight in the range of 5 to 100 grams per square meter.

16. A wrapping material according to claim 2 wherein said second thermoplastic film has a thickness in the range of 0.2-4.0 mils.

17. A wrapping material according to claim 2 wherein said second thermoplastic film has a weight in the range of 5 to 100 grams per square meter.

18. The use of the wrapping material of claim 1 for wrapping industrial products.

19. The use of the wrapping material according to claim 1 as a geomembrane.

20. The use of the wrapping material according claim 1 for covering temporary building structures.

21. The use of the wrapping material according to claim 1 as a landfill cover.

22. The use of a wrapping material according to claim 1 as a pond liner.

23. The use of a wrapping material according to claim 1 as a hay tarp.
